(19) United States
(12) Patent Application Publication
(10) Pub. No.: US 2025/0001976 A1
(43) Pub. Date: Jan. 2, 2025

(54) SINGLE-PIECE ARM OF A WIPING SYSTEM COMPRISING A PLURALITY OF LONGITUDINAL BEAMS

(71) Applicant: VALEO SYSTÈMES D'ESSUYAGE, Le Mesnil Saint Denis (FR)

(72) Inventors: Gerald Caillot, Le Mesnil Saint Denis (FR); Alexandre Filloux, Le Mesnil Saint Denis (FR); Jean-Michel Jarasson, Le Mesnil Saint Denis (FR); Vincent Izabel, Le Mesnil Saint Denis (FR)

(73) Assignee: VALEO SYSTÈMES D'ESSUYAGE, Le Mesnil Saint Denis (FR)

(21) Appl. No.: 18/688,301

(22) PCT Filed: Aug. 30, 2022
(86) PCT No.: PCT/EP2022/074135

§ 371 Date: Feb. 29, 2024

(30) Foreign Application Priority Data
Aug. 31, 2021 (FR) 2109058

(51) Int. Cl. B60S 1/34; B60S 1/38

(52) U.S. Cl. CPC B60S 1/3431; B60S 1/3849

(57) ABSTRACT

An arm of a wiping system is disclosed. The arm includes a part extending longitudinally. The part is configured to be connected by a first end to an arm drive device and by a second end to an attachment device for attaching the arm to a wiper blade. The part includes a main beam extending in the longitudinal direction. The part is in a single piece and the part also includes at least one additional beam extending in the longitudinal direction.

The present invention relates to the field of vehicle wiping systems. More particularly, the invention relates to an arm capable of driving a wiper blade.

Visibility through the glazed surfaces of a vehicle, notably the front windshield or the rear window, is essential in order for a user to be able to drive the vehicle in an entirely safe manner. Depending on the environmental conditions, these glazed surfaces become dirty more or less quickly, with the consequence of impairing the visibility through these glazed surfaces. It is therefore important to be able to clean them even when the vehicle is being used.

An arm of a wiping system according to the prior art may comprise a metal casing, steel for example, on which is mounted a plastic cover with a dual tube specifically for conveying a cleaning fluid.

The plastic cover serves to close off the arm, to mechanically protect the dual tube and to improve aerodynamic performance. However, such an arm is heavy, due to the use of metal, with poor optimization in terms of its manufacturing process, which requires steps of stamping and injection molding in particular.

The present invention aims to overcome at least one of the aforementioned disadvantages, as well as to afford other advantages by proposing a novel type of arm that is both easy to manufacture and more lightweight and robust, making it possible to withstand the stresses to which the arm is subjected, while also having good aerodynamic performance.

The present invention proposes an arm of a wiping system, comprising a part extending longitudinally, the part being configured to be connected by a first end to an arm drive device and by a second end to an attachment device for attaching the arm to a wiper blade, the part comprising a main beam extending in the longitudinal direction. According to the invention, the part is in a single piece and the part further comprises at least one additional beam extending in the longitudinal direction.

A single-piece part simplifies the manufacturing process in that it does not require any assembly steps. The part may in particular be produced by three-dimensional printing, which uses lightweight materials, such as plastic for example, or metal, such as steel, aluminum, titanium, etc. In addition, the fact that it comprises two beams makes it possible to increase the resistance of the arm to the mechanical stresses that the arm undergoes during its operation.

The term “beam” means a reinforcing structural element. This reinforcing structural element makes it possible to increase the resistance of the arm to the mechanical stresses that the arm undergoes during its operation in the longitudinal direction and/or the transverse direction and/or the vertical direction.

Thus, the main beam and the at least one additional beam are reinforcing structural elements, configured to increase the resistance of the arm to the mechanical stresses that the arm undergoes during its operation in the longitudinal direction and/or the transverse direction and/or the vertical direction.

According to one embodiment, the additional beam and the main beam may extend longitudinally substantially parallel to one another.

The additional beam thus makes it possible to reinforce the arm longitudinally and/or transversely and/or vertically.

According to one embodiment, the at least one additional beam and the main beam are offset transversely and/or vertically.

According to one embodiment, the additional beam may be connected to the main beam by two longitudinal ends of the additional beam, in particular close to the first and second ends of the single-piece part.

Such an embodiment improves the robustness associated with the join between the main beam and the additional beam. In particular, it makes it possible to have a common trunk from which the main beam and the additional beam stem.

The common trunk may be considered to form part of the main beam.

In addition, the additional beam may also be connected to the main beam by at least one transverse rib.

A rib makes it possible to reinforce the rigidity of the single-piece part, and to prevent deformation when the arm is subjected to stress.

The transverse rib may have a lattice structure.

Such a structure makes it possible to reinforce the strength of the arm while minimizing the addition of material. A good compromise between weight and strength is thus ensured.

According to one embodiment, the main beam may be closer to a glazed surface than the additional beam, when the arm of the wiping system is in the operating position.

The center of gravity of the arm is thus close to the glazed surface, which helps press a wiper blade on the glazed surface.

According to one embodiment, the part may comprise a first additional beam and a second additional beam.

The use of two additional beams increases the strength of the arm. In particular, the two additional beams may be dedicated to reinforcing the arm vis-a-vis stress in different directions.

In addition, the first additional beam may extend longitudinally above the main beam relative to a glazed surface when the arm is in the operating position, in particular from the first end of the part, or close to the first end of the part, to the second end of the part.

The first additional beam thus makes it possible to reinforce the arm vis-a-vis longitudinal stress. In particular, the connection with an arm drive element may give rise to such stress, notably when the connection comprises a spring.

According to one embodiment, the second additional beam may extend longitudinally on the side of the main beam, in particular from the first end of the part, or close to the first end of the part, to the second end of the part.

According to one embodiment, the second additional beam may extend longitudinally behind the main beam relative to a downward direction of wiping of the arm, when the arm is in the operating position.

Such an additional beam in the lateral position makes it possible to reinforce the arm vis-a-vis longitudinal twisting and vis-a-vis stress in the direction of wiping of the arm. Moreover, the rearward position of the second additional beam makes it possible to promote the aerodynamics of the arm when the shapes of the main beam and the additional beams are configured to perform an aerodynamic function.

According to one embodiment, the first additional beam may extend longitudinally above the second additional beam relative to a glazed surface, when the arm is in the operating position.

According to one embodiment, the first additional beam may extend longitudinally beside the second additional beam relative to a glazed surface, when the arm is in the operating position.

According to one embodiment, the main beam, the first additional beam and/or the second additional beam extend in at least two different planes, and preferably in three different planes.

According to one embodiment, the different planes are substantially parallel.

According to one embodiment, the main beam, the first additional beam and/or the second additional beam are offset transversely and/or vertically.

According to one embodiment, the main beam has a cross section the surface area of which is greater than that of the at least one additional beam.

According to one embodiment, the surface area of the cross section of the main beam is two to three times greater than that of the at least one additional beam.

According to one embodiment, the main beam and the at least one additional beam are arranged such that air circulates around each of them.

According to one embodiment, the at least one additional beam is arranged at a distance of at least 5 mm from the main beam, preferably at least 6 mm from the main beam.

According to one embodiment, the at least one additional beam is arranged at a distance of between 5 mm and 25 mm from the main beam, preferably at a distance of between 6 mm and 20 mm from the main beam.

According to one embodiment, the additional beam and the main beam may have cross sections in the shape of an inverted airplane wing.

Such shapes make it possible to improve the aerodynamics of the arm. To be specific, the aerodynamic function is enabled by combined considera-tion of the relative position of the beams and their shapes.

In addition, the inverted airplane wing shape of the main beam may define a first orientation and the inverted airplane wing shape of the additional beam defines a second orientation, and the first and second orientations may be adapted to achieve negative lift of the arm.

The negative lift, also referred to below as downforce, is thus improved, which helps press a wiper blade on the glazed surface.

A second aspect of the invention relates to an arm according to the first aspect of the invention in which the part is also in a single piece with at least one longitudinal channel adapted to ensure the reception of a cleaning fluid on the first end and to convey the cleaning fluid along the part.

Thus, manufacture of the arm is simplified compared to prior art solutions. This makes it possible in particular to avoid the assembly stress intrin-sic to solutions which use a plurality of elements to create the arm. Further-more, the arm may incorporate a cleaning fluid conveying function as well as a wiper blade drive function, by virtue of a single piece.

According to one embodiment, said at least one longitudinal channel may be formed by a cavity in the single-piece part.

According to one embodiment, said at least one longitudinal channel may be formed within the main beam.

Thus, the longitudinal channel is produced through the absence of material in the single-piece part, which is economical, easy to manufacture and makes the arm more lightweight.

According to one embodiment, the part may be made of plastic or metal.

Thus, the part has the rigidity required for a windshield wiper arm, as well as being more lightweight, particularly compared to metal arms comprising several attached parts. Moreover, an arm with a single-piece part may be manufactured by three-dimensional printing. Such production is clearly simplified compared to the manufacture of prior art arms which requires steps of cutting, stamping, welding and/or crimping. To be specific, the single-piece part directly integrates the functions performed by the additional parts added to prior art arms, such as tubes, retaining clips, plastic cover, etc.

According to one embodiment, the part may comprise two longitudinal channels, each longitudinal channel being dedicated to one direction of wiping of the arm out of an upward direction and a downward direction.

This makes it possible to spray the cleaning fluid in front of the wiper blade, regardless of the direction of wiping of the blade and the arm. The efficiency associated with cleaning a glazed surface is thus improved.

According to one embodiment, the part may further comprise a receiving cannula for each longitudinal channel, the receiving cannula being formed on the first end and being adapted to receive the cleaning fluid.

Thus, a single part not only conveys but also receives the cleaning fluid. A receiving cannula improves the sealing of the single-piece part.

According to one embodiment, the part may comprise at least one sub-channel between the longitudinal channel and an outer surface of the part, the sub-channel being capable of spraying the cleaning fluid passing through the channel toward an area of wiping of the wiper blade.

Thus, the single-piece part also makes it possible to perform the function of dispersing the cleaning fluid, while limiting the number of components associated with this function.

In addition, each sub-channel is shaped to receive at least one non-return valve, in particular by a groove obtained by localized widening of a cross section of the sub-channel.

A non-return valve improves the sealing of the single-piece part, preventing cleaning fluid from flowing back into the longitudinal channel from the sub-channel. The non-return valve also improves the response time of the fluid dispersion function, because the fluid is always ready in the arm.

In addition or as an alternative, each sub-channel may be shaped to receive at least one spray element, in particular by a groove obtained by localized widening of a cross section of the sub-channel. This function may be achieved in a simple manner, and inexpensively in terms of manufacturing, for example by inserting the non-return valve into the channel.

Alternatively, the arm may further comprise a spray element fixed op-posite each sub-channel, on an outer surface of the part, and each spray element may be welded to the outer surface.

The manufacture of the single-piece part is thus simplified.

According to another embodiment, the longitudinal channel may be adapted to convey the cleaning fluid from the first end to the second end.

This other embodiment makes it possible to perform the function of dispersing the cleaning fluid in the wiper blade. The arm may thus comprise only the single-piece part, which simplifies its manufacturing and assembly.

In addition, the part may further comprise an outlet cannula on the second end, the outlet cannula being adapted to deliver the cleaning fluid conveyed in the longitudinal channel to the blade.

Sealing of the single-piece part is thus improved, without requiring any additional element.

A third aspect of the invention relates to a method for manufacturing an arm according to the first aspect of the invention, wherein the part is obtained by three-dimensional printing.

A fourth aspect of the invention relates to a wiping system comprising an arm according to the first aspect of the invention, a drive device connected to the first end of the arm, an attachment device connected to the second end of the arm, the attachment device connecting the arm to a wiper blade of the system.

Other features and advantages of the invention will become more clearly apparent both from the following description and from several exemplary embodiments, which are provided by way of non-limiting indication with reference to the attached schematic drawings, in which:

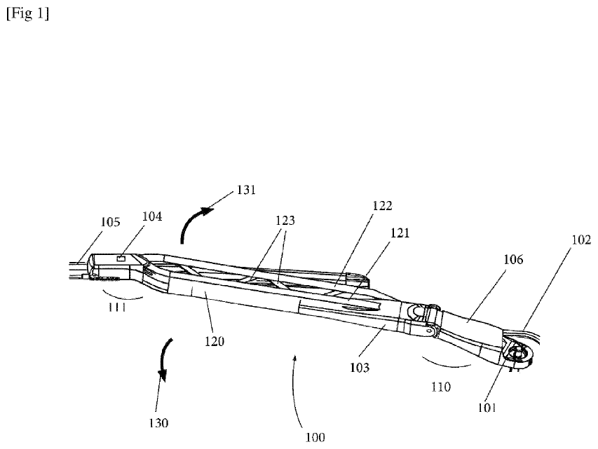

FIG. 1 depicts a wiping system for a motor vehicle according to an embodiment of the invention;

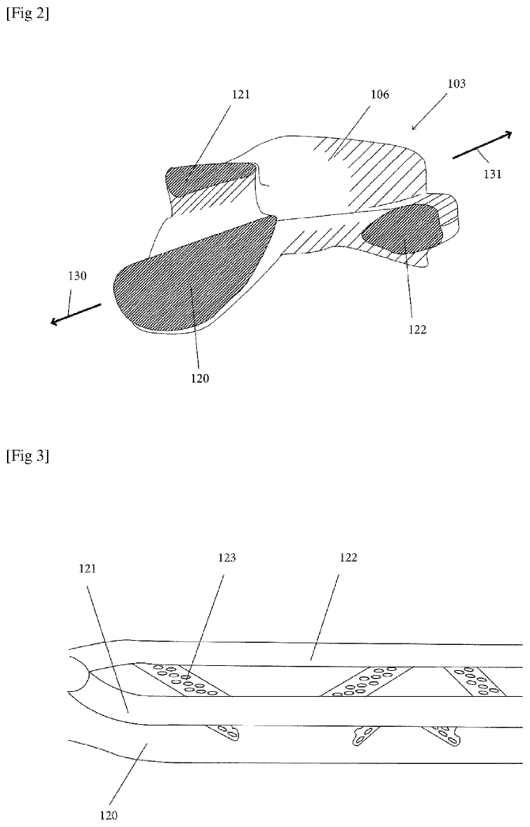

FIG. 2 depicts a cross section through a single-piece part of an arm of a wiping system according to an embodiment of the first aspect of the invention;

FIG. 3 depicts ribs joining beams of an arm of a wiping system according to an embodiment of the first aspect of the invention;

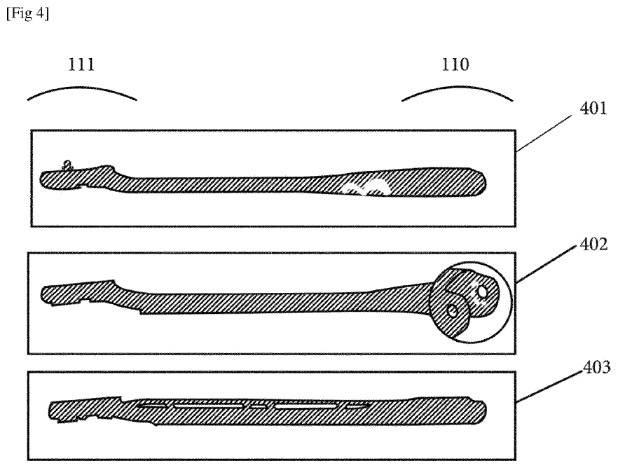

FIG. 4 shows a comparison between the respective strengths of arms of the prior art and according to the invention, vis-a-vis longitudinal stress;

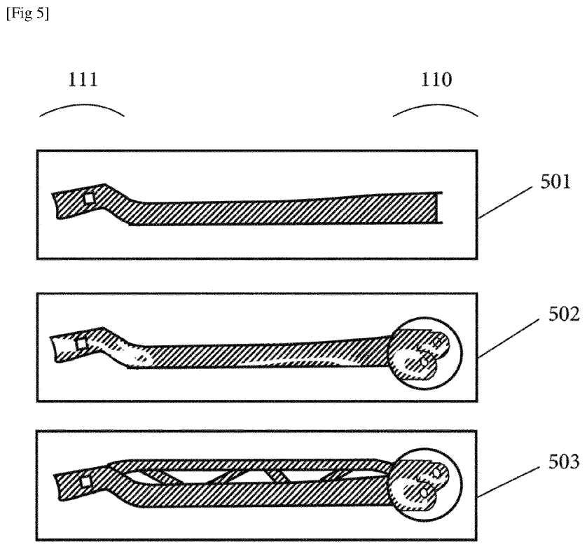

FIG. 5 shows a comparison between the respective strengths of arms of the prior art and according to the invention, vis-a-vis lateral stress;

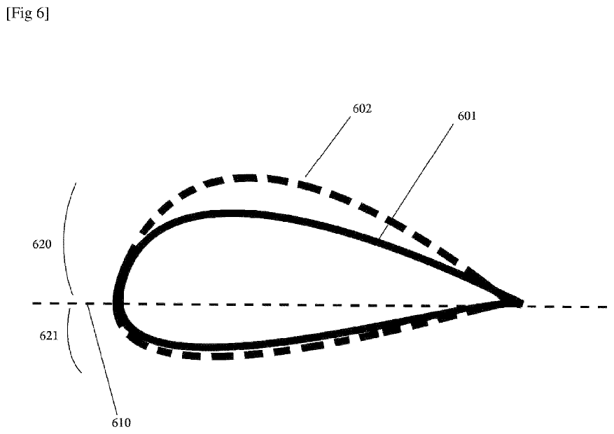

FIG. 6 depicts shapes of cross sections of beams of an arm of a wiping system according to an embodiment of the first aspect of the invention;

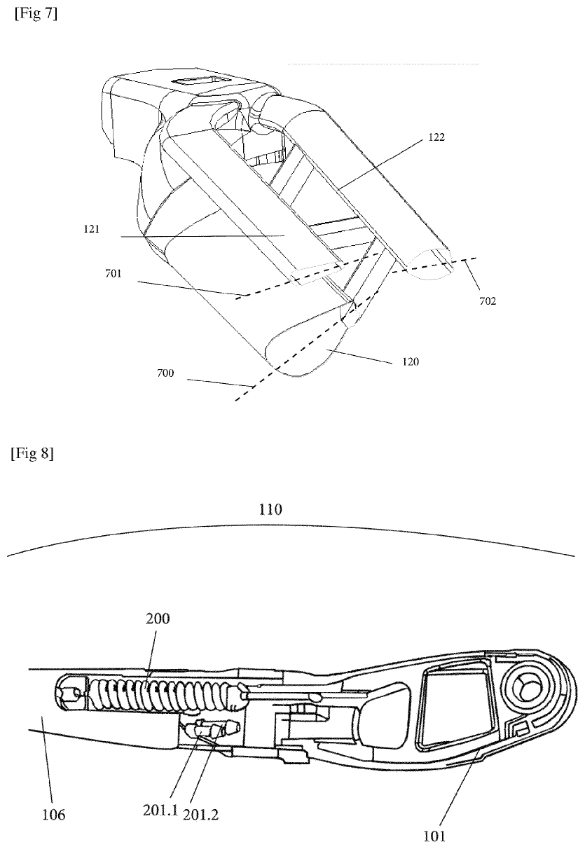

FIG. 7 depicts the respective orientations of beams of an arm of a wiping system according to an embodiment of the first aspect of the invention;

FIG. 8 depicts a first end of a single-piece part of an arm of a wiping system according to embodiments of the second aspect of the invention;

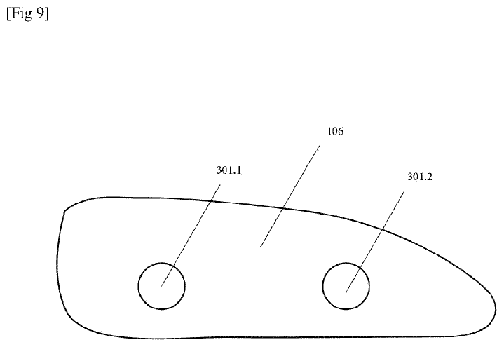

FIG. 9 depicts a cross section through a single-piece part of an arm according to a first embodiment of the second aspect of the invention;

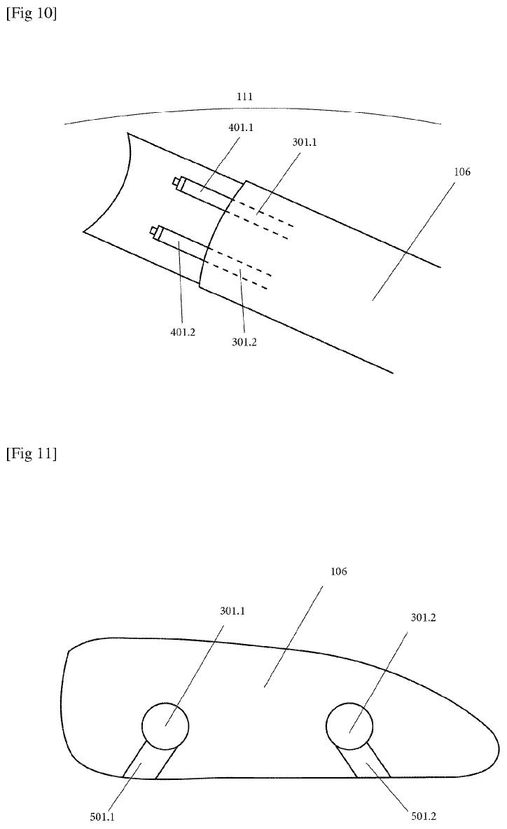

FIG. 10 depicts a second end of a single-piece part of an arm of a wiping system according to the first embodiment of the second aspect of the invention;

FIG. 11 depicts a cross section through a single-piece part of an arm of a wiping system according to a second embodiment of the second aspect of the invention;

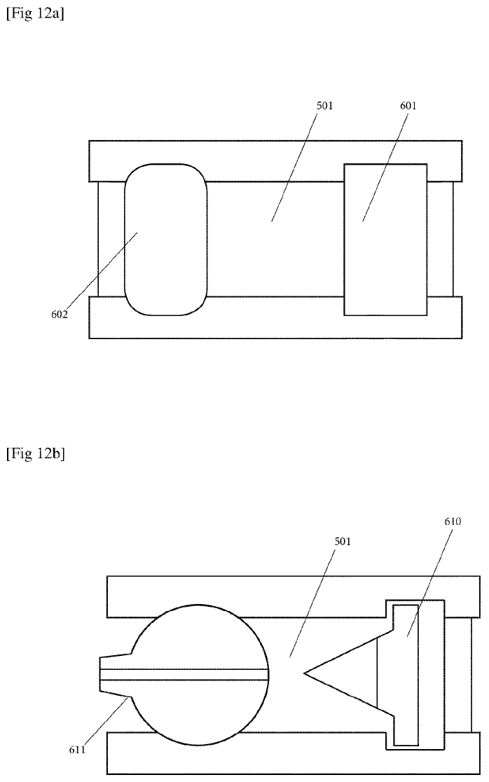

FIG. 12a depicts a longitudinal section through a sub-channel of a single-piece part of an arm of a wiping system according to the second embodiment of the second aspect of the invention;

FIG. 12b shows the same section as FIG. 12a, but with additional elements incorporated in the single-piece part, according to the second embodiment of the second aspect of the invention;

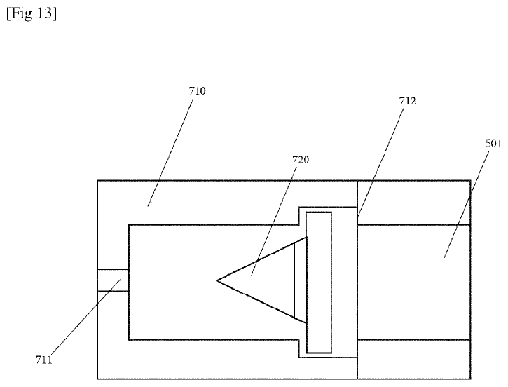

FIG. 13 depicts a longitudinal section through a variant of a sub-channel of the arm of a wiping system according to the second embodiment of the second aspect of the invention.

It should first of all be noted that, although the figures set out the invention in detail for the implementation thereof, they may of course be used to better define the invention, where appropriate. It should also be noted that, in all of the figures, components that are similar and/or perform the same function are indicated using the same numbering.

FIG. 1 depicts a wiping system 100 according to an embodiment of the invention. The wiping system 100 is suitable for being installed on a glazed surface of a vehicle, such as for example a windshield, a rear window or a glazing.

The wiping system comprises at least one arm 103, a wiper blade 105 attached to the arm 103 by an attachment device 104, and a drive device 101 for the arm 103.

According to the invention, the arm 103 comprises a single-piece part 106. In FIG. 1, the arm 103 and the single-piece part 106 are one and the same entity and are combined. However, the arm 103 may include elements other than the single-piece part 106.

The drive device 101 is configured to set the wiper blade 105 in motion via the arm 103, the wiper blade 105 being in contact with the glazed surface. The movement of the arm 103 is typically a back and forth movement which may be a linear and/or angular movement.

FIG. 1 defines in particular a downward direction of wiping 130 and an upward direction of wiping 131. The upward direction of wiping is directed toward the roof of a motor vehicle when the wiping system is in the operating position and fitted on such a vehicle.

The arm 103 keeps the wiper blade 105 in contact with the glazed surface.

The structure of the wiper blade 105 is not described further below, but no restriction is imposed on it. The wiper blade 105 may in particular comprise a body forming a holder for a wiper strip capable of wiping a glazed surface.

No restriction is moreover imposed on the attachment device 104, which is adapted to allow mechanical attachment of the wiper blade 105 to the arm 103. Mechanical attachment may in particular be performed by clamping, by fitting together, or by any other means. No restriction is moreover imposed on the degrees of freedom permitted by the mechanical connection of the attachment device 104.

The wiping system 100 according to the invention may further comprise a conveying device 102 for conveying a cleaning fluid from a tank, not shown in FIG. 1 (see FIGS. 8 to 13), to the arm 103. The cleaning fluid is intended to be conveyed and dispersed over the glazed surface and will be discussed in more detail below.

As shown in FIG. 1, the single-piece part 106 extends longitudinally so as to transmit the driving forces from the drive device 101 to the wiper blade 105, while ensuring that the wiper blade 105 remains pressed against the glazed surface. To this end, the single-piece part 106 is connected by a first longitudinal end 110 to the drive device 101 and by a second longitudinal end 111 to the wiper blade 105 via the attachment device 104.

According to the invention, the single-piece part 106 comprises a main beam 120 and at least one additional beam 121. The fact that two beams are used, combined with the use of lightweight materials and manufacturing by three-dimensional printing, makes it possible to lighten the arm 103 on the one hand, while making it possible to strengthen the resistance to the mechanical stresses applied to the arm 103. To be specific, the main beam 120 and the at least one additional beam 121, 122 are reinforcing structural elements, configured to increase the resistance of the arm to the mechanical stresses that the arm 103 undergoes during its operation, in various directions.

Lastly, such advantages are attained with a sole part 106, which simplifies its manufacture and reduces its production costs. For example, the single-piece part 106 may be made of plastic or metal, and be produced by three-dimensional printing.

According to the embodiment illustrated in FIG. 1, the single-piece part 106 comprises several additional beams, namely a first additional beam 121 and a second additional beam 122. No restriction is imposed on the number of additional beams according to the invention, which may be any number greater than or equal to 1.

The main beam 120 and the additional beams 121, 122 are arranged such that air circulates around each of them.

More particularly, the at least one additional beam 121, 122 is arranged at a distance of at least 5 mm from the main beam 120, preferably at least 6 mm from the main beam 120.

Each additional beam 121 or 122 extends longitudinally parallel to the main beam 120. Each additional beam 121 or 122 may be connected to the main beam via its respective longitudinal ends, in particular close to the first and second ends 110 and 111 of the single-piece part 106.

In addition, the single-piece part 106 may comprise at least one transverse rib 123 transversely connecting the main beam 120 to an additional beam 121 or 122. A transverse rib means a rib in a direction other than the longitudinal direction in which the main beam 120 mainly extends. For example, the transverse rib 123 may be inclined by more than 300 relative to the longitudinal direction. In FIG. 1, several ribs 123 are shown, with inclinations of the order of 60° relative to the longitudinal direction.

The ribs 123 make it possible to improve the resistance of the arm 103 to impacts and stress, while allowing a part 106 to be made in a single piece. Advantageously, the ribs may have a lattice structure, which makes them more lightweight while retaining the mechanical advantages associated with the ribs. The main beam and the additional beam may also have a lattice structure in order to make the arm more lightweight.

No restriction is imposed on the number of ribs or their respective longitudinal positions. Preferably, the ribs 123 are spaced evenly along the length of the additional rib 121 or 122. For example, a single rib, or a pair of ribs, is provided between the main beam 120 and an additional beam 121 or 122 in the vicinity of the middle of the additional beam 121 or 122.

The first additional beam 121 extends longitudinally above the main beam 120 relative to a glazed surface, when the wiping system is in the operating position. The first additional beam 121 thus makes it possible to increase the resistance of the single-piece part 106 vis-a-vis the stress applied in a vertical direction substantially normal to the plane of wiping of the arm 103, corresponding to the plane of the glazed surface. Such stress is applied in particular when a user pulls on the wiping system 100 to move it away from the glazed surface or as a result of the force applied by the arm on the wiper blade.

The second additional beam 122 extends longitudinally beside and/or behind the main beam relative to an upward direction of wiping of the arm, when the wiping system is in the operating position. The second additional beam 122 thus makes it possible to increase the resistance of the single-piece part 106 vis-a-vis twisting stress along the longitudinal axis, and/or vis-a-vis lateral stress in the direction of wiping. Stress in the direction of wiping may occur owing to solid deposits on the glazed surface, for example snow, or when the vehicle is moving at high speed, whether the wiping system is moving or not.

Advantageously, the second additional beam 122 is located behind the main beam 120 relative to the downward direction of wiping 130. Such an ar-rangement improves the aerodynamics of the arm 103 in the downward direction in which the arm faces the air current striking the glazed surface when the glazed surface is a windshield. According to one embodiment and as can be seen in FIG. 2, the first additional beam 121 extends longitudinally above and beside the second additional beam 122 relative to a glazed surface, when the arm 103 is in the operating position.

Thus, the main beam 120, the first additional beam 121 and the second additional beam 122 extend in at least three different planes.

The main beam 120, the first additional beam 121 and the second additional beam 122 are offset transversely and/or vertically relative to one another.

FIG. 2 depicts a cross section through a single-piece part 106 of an arm 103 according to an embodiment of the invention.

The cross section is in a plane perpendicular to the longitudinal direction in which the single-piece part 106 mainly extends.

The section in FIG. 2 corresponds to a longitudinal position close to the first end 110. A similar cross section is obtained at the second end 111.

As can be seen in FIG. 2, the main beam 120 and the additional beams 121 and 122 are connected to a common trunk of the single-piece part 106. The common trunk may be considered to form part of the main beam 120.

A beam is referred to as the main beam when its cross section has a greater surface area than the other beam, or other beams, which are then referred to as additional. The surface area of the cross section of the main beam 120 may in particular be two to three times greater than those of the additional beams 121 and 122.

The main and additional beams may have the shape of an inverted airplane wing. However, several inverted airplane wing shapes may be provided as will be better understood on reading the following, in particular the description of FIG. 6.

FIG. 3 depicts more specifically ribs 123 of an arm of a wiping system 100 according to an embodiment of the invention.

The ribs 123 advantageously have a lattice structure making the ribs 123, and therefore the arm 103, more lightweight while mechanically reinforcing the structure of the single-piece part 106.

A single-piece part 106 with such ribs 123 may also be produced by three-dimensional printing.

FIG. 4 depicts examples of the application of longitudinal stress to a prior art arm, an arm with a single beam, and an arm with a main beam and two additional beams according to an embodiment of the invention.

The three arms are subjected to the same longitudinal stress. Such longitudinal stress is generally applied by a spring providing the connection between the arm 103 and the drive device 101 at the first end 110.

These examples were obtained experimentally on the basis of specific values linked to a given design, a given arm length and a given blade length, in particular. However, these examples are described in order to illustrate the benefits of the arm according to the invention.

Box 401 shows an arm according to the prior art with a steel casing. Such an arm has a weight of around 336 grams, and undergoes a maximum deformation of around 0.6 mm and a maximum pressure per unit area of around 964 MPa. The maximum pressure is visible and indicated close to the first end. This pressure is higher than the yield strength of the steel, which is 200 MPa. Thus, the stress applied causes the arm in box 401 to break.

Box 402 shows an arm with a single-piece part made of plastic, such as PA11 for example, comprising a single beam. Such an arm has a weight of 111 grams, and undergoes a maximum deformation of around 16 mm and a maximum pressure per unit area of 99 MPa. The maximum pressure is visible and indicated at the first end 110, more specifically at the lugs for connection to the drive device 101. The maximum pressure is higher than the yield strength of the PA11, which is 45 MPa, and the stress applied causes the arm to break at the lugs at the first end 110.

Box 403 shows an arm comprising a single-piece part 106 made of plastic, such as PA11 for example, comprising a main beam and two additional beams, according to an embodiment of the invention. Such an arm has a weight of 145 grams, and undergoes a maximum deformation of around 3.7 mm and a maximum pressure per unit area of around 23 MPa. The maximum pressure is lower than the yield strength of the PA11, which is 45 MPa, and the stress applied does not cause the arm to break. The arm 103 according to the invention thus allows greater resistance to longitudinal stress, for a lower weight, compared to the prior art solution in box 401. Moreover, the manufacture of the arm 103 is simplified and has a lower cost.

FIG. 5 depicts examples of the application of lateral stress to a prior art arm, an arm with a single beam, and an arm with a main beam and two additional beams according to an embodiment of the invention.

The three arms are subjected to the same lateral stress. Lateral stress is stress applied perpendicular to the direction of wiping of the arm 103. Such lateral stress is generally applied by solid elements on the glazed surface, such as snow for example, which exert stress on the blade 105 which transmits the stress to the arm via the attachment device. They thus involve lateral forces as well as twisting on the arms.

These examples were obtained experimentally on the basis of specific values linked to a given design, a given arm length and a given blade length, in particular. However, they are described in order to illustrate the benefits of the arm according to the invention.

Box 501 shows an arm according to the prior art with a steel casing, similar to the arm in box 401 of the previous figure. In the example in question, such an arm has a weight of around 336 grams, and undergoes a maximum deformation of around 1.3 mm and a maximum pressure per unit area of around 157 MPa. The maximum pressure is indicated close to the second end 111. This pressure is lower than but close to the yield strength of the steel, which is 200 MPa.

Box 502 shows an arm with a single-piece part made of plastic, such as PA11 for example, comprising a single beam, similar to the arm in box 402 of the previous figure. Such an arm has a weight of 111 grams, and undergoes a maximum deformation of around 51 mm and a maximum pressure per unit area of 195 MPa. The maximum pressure is visible and indicated at the first end 110, in particular the lugs, as well as in the middle of the beam and at the second end, in other words close to the connection with the blade 105. The maximum pressure is higher than the yield strength of the PA11, which is 45 MPa, and the stress applied causes the arm to break, possibly at several points.

Box 503 shows an arm comprising a single-piece part 106 made of plastic, such as PA11 for example, comprising a main beam and two additional beams, according to an embodiment of the invention. Such an arm has a weight of 145 grams, and undergoes a maximum deformation of around 14 mm and a maximum pressure per unit area of 112 MPa. However, the maximum pressure is only located at the lugs, and no longer in the middle of the main beam or at the second end 111. It is thus possible, by reinforcing the lugs, to provide resistance to lateral stress similar to the prior art solution, for a reduced weight and simpler and less expensive manufacturing. No restriction is imposed on the elements for reinforcing the lugs, which are well known to those skilled in the art.

FIG. 6 depicts two airplane wing shapes according to embodiments of the invention.

An airplane wing shape mainly comprises two curves 620 and 621 which define an axis of orientation 610 of the airplane wing. As stated above, such shapes are preferentially used for the shape of the cross sections of the main beam 120 and the additional beams 121 and 122.

The airplane wing shapes in FIG. 6 generate lift. An inverted airplane wing shape is obtained by vertical symmetry of the airplane wing shape shown in FIG. 6. Such an inversion makes it possible to promote negative lift, or downforce, and thus allows the wiper blade to be pressed on the glazed surface.

Several shapes 601 and 602 are possible, and may be chosen according to the stress applied to the wiping system 100, depending on the number of additional beams and other technical constraints in particular. The shapes 601 and 602 are chosen in particular in order to improve the aerodynamics of the single-piece part 106 and to promote downforce thereof. A significant downforce value keeps the wiper blade 105 pressed against the glazed surface.

FIG. 7 depicts the respective orientations of the beams of a single-piece part of an arm according to an embodiment of the invention.

The beams 120, 121 and 122 all have inverted airplane wing shapes, which thus define respective orientations of the beams.

The main beam 120 has a first orientation 700, the first additional beam 121 has a second orientation 701 and the second additional beam 122 has a third orientation 702.

The angles between the orientations 700, 701 and 702 may be defined according to the number of additional beams, their shapes and other technical constraints in particular. The angles between the orientations 700, 701 and 702 are chosen in particular in order to improve the aerodynamics of the single-piece part 106 and to promote downforce thereof.

The same applies to a single-piece part 106 comprising a single additional beam. In this case, the angle between the orientations of the main beam and the additional beam is defined according to the aforementioned stress.

It is thus possible to optimize the strength of the arm 103, and the weight and the aerodynamics thereof. In particular, the respective orientations of the beams of the single-piece part 106 according to the invention may be determined in such a way as to allow negative lift, or downforce, of the single-piece part 106, thus helping to press the blade 105 on the glazed surface.

In practice, a single-piece part with three beams allows greater downforce than that obtained with the prior art solution presented above.

Whatever the embodiment of the arm 103 with a single-piece part 106 according to the invention, the single-piece part 106 forms a sole part which cannot be taken apart without causing damage to at least one of its constituent components. The components of the single-piece part 106 are made of the same material or materials. This part therefore differs from elements that are joined together by welding, bonding, clipping, force-fitting or another method.

The single-piece part 106 is produced by means of a manufacturing method using at least one synthetic material, such as a plastic or metal.

The method for manufacturing the single-piece part 106 comprises a step of three-dimensional printing with additive layers. The entire single-piece part 106 is produced by three-dimensional printing with additive layers.

According to the second aspect of the invention, the single-piece part further comprises at least one longitudinal channel adapted to ensure the reception of a cleaning fluid on the first end 110 and to convey the cleaning fluid along the single-piece part 106. The cleaning fluid thus conveyed is then sprayed, either by the arm 103 or by the wiper blade 105. Preferably, said at least one longitudinal channel is provided within the main beam 120.

The manufacture of a single-piece part is simplified. For example, the single-piece part 106 may be made of plastic or metal, and be produced by three-dimensional printing. Manufacturing costs are thus reduced, the manufacturing process is simplified, while making it possible to carry out the function of conveying the cleaning fluid without the need for additional parts. Most of the disadvantages of the prior art are thus overcome. The longitudinal channel may be formed by a cavity in the single-piece part 106. Thus, the channel is not an additional part, but is obtained by forming a cavity through the absence of material.

The single-piece part may comprise two channels, each channel being dedicated to one direction of wiping of the arm 103 and the wiper blade 105, out of an upward direction and a downward direction. An upward direction may correspond to a wiping movement from the hood of the vehicle toward the roof, when the glazed surface is a windshield. This ensures that the cleaning fluid is always sprayed in front of the wiper blade. This makes it possible to improve the driver's visibility through the glazed surface and to make wiping by the wiper blade 105 more efficient.

FIG. 8 shows the first end 110 of the single-piece part 106. The first end 110 may be connected to the drive device 101 via drive means comprising a spring 200. No restriction is imposed on the drive means, the example of the spring 200 being given purely for illustrative purposes.

As shown in FIG. 8, the single-piece part 106 may further comprise a receiving cannula for each longitudinal channel of the single-piece part 106. In the remainder of the description, it is considered, purely for illustrative purposes, that the single-piece part 106 comprises two longitudinal channels. Consequently, FIG. 8 shows two receiving cannulas 201.1 and 201.2. Each receiving cannula 201.1 and 201.2 is formed on the first end 110 and is adapted to receive the cleaning fluid, for example by connecting the conveying device 102 shown in FIG. 1 thereto. Two conveying devices 102 may thus be provided to connect each receiving cannula 201.1 and 201.2 to the tank of cleaning fluid. Each receiving cannula 201.1 or 201.2 may thus have a shape complementary to the conveying device 102, in particular to an outlet of the conveying device 102. Thus, when the conveying device 102 is tubular as in FIG. 1, the receiving cannula 201.1 or 201.2 may have a cylindrical shape with a radius equal to or slightly greater than an internal radius of the conveying device. Thus, the conveying device 102 may be deformed so as to grip the receiving cannula, thus ensuring that the connection is sealed. Other solutions may be considered for connecting the conveying device 102 to the receiving cannula 201.1 or 201.2. The present invention is thus not limited to the example of FIG. 8. The receiving cannulas 201.1 and 201.2 may in particular have a cylindrical shape with a tapered section so as to facilitate insertion into a tubular conveying device 102. Alternatively, the size of the section of the receiving cannulas 201.1 and 201.2 may be constant.

FIG. 9 depicts a cross section through the single-piece part 106 of an arm 103 according to a first embodiment of the invention.

The cross section is a section in a plane perpendicular to the longitudinal direction in which the single-piece part 106 mainly extends. The cross section thus shows a portion of the single-piece part 106 according to the first embodiment of the invention.

According to the first embodiment of the invention, illustrated in FIGS. 9 and 10, the single-piece part 106 of the arm 103 ensures that the cleaning fluid is conveyed from the first end 110 to the second end 111 located on the wiper blade 105 side. According to this first embodiment, it is the wiper blade 105 which performs the function of sprinkling, or dispersing, the cleaning fluid on the glazed surface. The single-piece part thus makes it possible to convey the cleaning fluid to the wiper blade 105, without the need to add parts to the arm 103.

Therefore, each cross section of the single-piece part is similar to the cross section shown in FIG. 8, with at least one longitudinal channel 301.1. In the example of FIG. 9, two longitudinal channels 301.1 and 301.2 have been shown, in accordance with the explanations set out above.

Note that the shape of the section of the single-piece part may vary depending on the longitudinal position considered. In general, and in order to improve the aerodynamics of the arm 103 while promoting pressing of the wiper blade 105 on the glazed surface, the single-piece part 106 may have a cross section in the shape of an inverted airplane wing, as shown in FIG. 9.

The channels 301.1 and 301.2 have a circular shape in the figures. However, note that no restriction is imposed on the shape of the channels 301.1 and 301.2, which may have any geometric or irregular shape, in order to facilitate the production of the single-piece part 106. For example, the channels 301.1 and 301.2 may have an oblong shape.

FIG. 10 depicts the second end 111 of the single-piece part 106 of an arm 103 according to the first embodiment of the invention.

In order to deliver the cleaning fluid conveyed in the channel 301.1, or in the channels 301.1 and 301.2, the single-piece part 106 may further comprise an outlet cannula 401.1, or two outlet cannulas 401.1 and 401.2, on or close to the second end 111.

Like the conveying device 102, another conveying device 102, also in tubular form for example, may be provided so as to be attached to the outlet cannula and connected to the wiper blade 105. If two outlet cannulas 401.1 and 401.2 are provided on the single-piece part 106, two other conveying devices may connect the outlet cannulas 401.1 and 401.2 to the wiper blade 105.

No restriction is imposed on the shape of the outlet cannulas 401.1 and 401.2, which may be identical to the receiving cannulas 201.1 and 201.2 or which may be different to the receiving cannulas 201.1 and 201.2. The outlet cannulas 401.1 and 401.2 may in particular have a cylindrical shape with a tapered section so as to facilitate insertion into a tubular conveying device. Alternatively, the size of the section may be constant.

FIGS. 11, 12a, 12b and 13 depict a single-piece part 106 of an arm 103 according to a second embodiment of the invention.

According to this second embodiment, it is the arm 103 which is in charge of the function of sprinkling, or dispersing, the cleaning fluid on the glazed surface.

FIG. 11 depicts a cross section through the single-piece part 106 of the arm 103 according to the second embodiment of the invention.

The section in FIG. 11 is identical to that in FIG. 9 in terms of its shape, may have one or more longitudinal channels 301.1 and 301.2, but further comprises, at certain longitudinal positions, at least one sub-channel 501.1. Preferably, when the single-piece part 106 comprises two longitudinal channels 301.1 and 301.2, the single-piece part 106 may comprise at least one sub-channel per longitudinal channel, in other words at least two sub-channels 501.1 and 501.2 at a given longitudinal position. The sub-channels 501.1 and 501.2 may be at different given longitudinal positions, in which case they are not visible in the same cross section. The longitudinal position may be identified relative to the distance to the first end 110 or to the second end 111.

Below, for the sake of simplification, the sub-channels 501.1 and 501.2 are shown at the same longitudinal position, and are therefore visible in the same cross section. No restriction is imposed on the position of the longitudinal position at which the sub-channels 501.1 and 501.2 are located. The longitudinal position of the sub-channels 501.1 and 501.2 may for example be close to the middle of the length of the single-piece part, or between the middle and three-quarters of the length starting from the first end 110. Alternatively, the longitudinal position may be between three-quarters of the length starting from the first end 110, and the second end 111. The longitudinal position may in particular be close to the second end.

In addition, several sub-channels 501.1 and 501.2 may be provided per longitudinal channel 301.1 and 301.2, at different longitudinal positions, so as to improve the dispersion of the cleaning fluid.

Each sub-channel is adapted to connect a longitudinal channel to the outer surface of the single-piece part 106, in such a way as to allow the dispersion of the cleaning fluid circulating in the longitudinal channel, outside the single-piece part 106. To this end, each sub-channel may have a cylindrical cross section, and may have a profile as shown in the figures which follow. As regards its length, the sub-channel therefore extends from the longitudinal channel 301.1 or 301.2 to the outer surface of the single-piece part 106. The sub-channels 501.1 and 501.2 have a circular shape in the figures. However, note that no restriction is imposed on the shape of the sub-channels 501.1 and 501.2, which may have any geometric or irregular shape, in order to facilitate the production of the single-piece part 106. For example, the sub-channels 501.1 and 501.2 may have an oblong shape.

The sub-channels 501.1 and 501.2 may have diameters smaller than the diameters of the longitudinal channels 301.1 and 301.2.

The sub-channels 501.1 and 501.2 open out at different positions on the outer surface of the single-piece part, in such a way as to disperse the cleaning fluid always in front of the wiper blade 105, as explained above. The position in front of the wiper blade 105 actually varies depending on whether the arm 103 has an upward or downward movement. The efficiency associated with cleaning the glazed surface is thus improved.

According to the second embodiment of the invention, the single-piece part 106 ensures that the cleaning fluid is conveyed longitudinally, but not necessarily as far as the second end 111, since it is not necessary to deliver the cleaning fluid to the wiper blade 105.

FIG. 12a depicts a longitudinal section through a sub-channel 501 of a single-piece part 106 of an arm 103 according to the second embodiment of the invention.

The sub-channel 501 of the single-piece part 106 comprises a first groove 601 and a second groove 602 at different longitudinal positions. As a reminder, the sub-channel 501 extends in length from the longitudinal channel 301.1 to the outer surface of the single-piece part 106. The first groove 601 is located on the side of as the longitudinal channel 301.1 while the second groove 602 is located on the side of the outer surface of the single-piece part 106. Thus, the cleaning fluid is dispersed from right to left in FIGS. 12a and 12b.

The term “groove” means any local variation in the diameter of the sub-channel 501, in particular a local enlargement, over a given length. The enlargement may be constant and discontinuous as for the groove 601 or may be variable and continuous as for the second groove 602.

FIG. 12b shows the same section as FIG. 12a, but with additional elements incorporated in the single-piece part 106, according to the second embodiment.

The first groove 601 is in particular shaped so as to accommodate, by insertion into the single-piece part 106, at least one non-return valve 610. No restriction is imposed on the shape of the non-return valve 610. In FIG. 12b, for illustrative purposes, the non-return valve 610 may comprise a cylindrical part and a conical part. The non-return valve 610 allows cleaning fluid to be taken in from the longitudinal channel to the sub-channel 501 while preventing the cleaning fluid from returning to the longitudinal channel once it has entered the sub-channel 501.

The second groove 602 is shaped so as to accommodate, by insertion into the single-piece part 106, a spray element 611. The function of the spray element 611 is to facilitate the dispersion of the cleaning fluid toward the glazed surface. In particular, it makes it possible to improve the precision associated with the dispersion of the cleaning fluid.

For example, the spray element 611 may have the shape of a pierced ball, with an internal channel of small diameter compared to the diameter of the section of the sub-channel 501.

In the case where the non-return valve 610 and the spray element 611 are inserted into the sub-channel 501, the non-return valve 610 is inserted before the spray element 611.

FIG. 13 depicts a longitudinal section through a variant of a sub-channel 501 of the arm 103 according to the second embodiment of the invention.

In the variant of FIG. 13, the sub-channel 501 has a constant section between the longitudinal channel and the outer surface of the single-piece part 106. An additional spray element 710 is attached to the single-piece part 106 in the arm 103 facing the sub-channel 501, so as to spray the cleaning fluid coming from the sub-channel 501 toward the glazed surface. As with the spray element 611, the spray element 710 facilitates the dispersion of the cleaning fluid toward the glazed surface and improves the precision associated with the dispersion of the cleaning fluid.

The spray element 710 may be attached by welding 712, in particular by ultrasonic welding, to the outer surface of the single-piece part 106, which simplifies the manufacture of the arm 103 according to the second embodiment of the invention.

The spray element 710 may comprise an intake surface adapted to be placed against the single-piece part 106, the intake surface having an internal diameter greater than the diameter of the sub-channel 501 so as to facilitate the intake of the cleaning fluid from the sub-channel 501.

The spray element 710 further comprises a dispersion section 711, with a narrowing of the section of the spray element 710 so as to facilitate dispersion toward the glazed surface.

The spray element 710 may further comprise a groove adapted to accommodate, by insertion, a non-return valve 720. The non-return valve 720 may have a shape similar to that of the non-return valve 610 described with reference to FIG. 12b.

The example in FIGS. 12a and 12b has the advantage of limiting the number of additional elements and the manufacture of the arm according to the second embodiment of the invention. In addition, the robustness of the arm is improved, since this example avoids the attachment of additional elements on the outer surface of the single-piece part 106.

The example of FIG. 13 has the advantage of simplifying the production of the single-piece part, according to the second embodiment of the invention.

Whatever the embodiment of the arm 103 with a single-piece part 106 according to the invention, the single-piece part 106 forms a sole part which cannot be taken apart without causing damage to at least one of its constituent components. The components of the single-piece part 106 are made of the same material or materials. This part therefore differs from elements that are joined together by welding or bonding.

The single-piece part 106 is produced by means of a manufacturing method using at least one synthetic material, such as a plastic, or a metal.

The method for manufacturing the single-piece part 106 comprises a step of three-dimensional printing with additive layers. The entire single-piece part 106 is produced by three-dimensional printing with additive layers.

Of course, the invention is not limited to the examples that have just been described and numerous modifications can be made to these examples without departing from the scope of the invention.

1. An arm of a wiping system,
the arm comprising a part extending longitudinally,
wherein the part is configured to be connected by a first end to an arm drive device and by a second end to an attachment device for attaching the arm to a wiper blade,
the part comprising a main beam extending in the longitudinal direction,
wherein the part is in a single piece, and
wherein the part further comprises at least one additional beam extending in the longitudinal direction.

2. The arm as claimed in claim 1,
wherein the main beam and the at least one additional beam are reinforcing structural elements, configured to increase the resistance of the arm to the mechanical stresses that the arm undergoes during its operation in the longitudinal, transverse, or vertical direction.

3. The arm as claimed in claim 1,
wherein the at least one additional beam and the main beam extend longitudinally substantially parallel to one another.

4. The arm as claimed in claim 1,
wherein the main beam and the at least one additional beam are arranged such that air circulates around each of them.

5. The arm as claimed in claim 1,
wherein the at least one additional beam and the main beam are offset transversely or vertically.

6. The arm as claimed in claim 1,
wherein the main beam is configured to be closer to a glazed surface than the at least one additional beam, when the arm of the wiping system is in the operating position.

7. The arm as claimed in claim 1,
wherein the at least one additional beam is connected to the main beam by two longitudinal ends of the at least one additional beam, close to the first and second ends of the single-piece part.

8. The arm as claimed in claim 7,
wherein the at least one additional beam is also connected to the main beam by at least one transverse rib.

9. The arm as claimed in claim 1,
wherein the part comprises a first additional beam and a second additional beam.

10. The arm as claimed in claim 9,
wherein the first additional beam and the second additional beam extend longitudinally above the main beam relative to a glazed surface when the arm is in the operating position, from the first end of the part, or close to the first end of the part, to the second end of the part.

11. The arm as claimed in claim 9,
wherein the second additional beam extends longitudinally behind the main beam relative to a downward direction of wiping of the arm, when the arm is in the operating position.

12. The arm as claimed in claim 9,
wherein the main beam, the first additional beam or the second additional beam extend in at least three different planes.

13. The arm as claimed in claim 1,
wherein the main beam has a cross section the surface area of which is greater than that of the at least one additional beam.

14. The arm as claimed in claim 1,
wherein the additional beam and the main beam have cross sections in the shape of an inverted airplane wing.

15. A wiping system comprising:
an arm as claimed in claim 1,
a drive device connected to the first end of the arm, and
an attachment device connected to the second end of the arm,
wherein the attachment device connects the arm to a wiper blade of the wiping system.
